(19) United States
(12) Patent Application Publication
(10) Pub. No.: US 2025/0371236 A1
(43) Pub. Date: Dec. 4, 2025

(54) ELECTRONIC DEVICE FOR SIMULATING PROPERTIES OF SEMICONDUCTOR DEVICE BY PREDICTING OXYGEN VACANCY AND OPERATION METHOD THEREOF

(71) Applicant: SAMSUNG ELECTRONICS CO., LTD., Suwon-si (KR)

(72) Inventors: Minhwan Lee, Suwon-si (KR); Sungjin Kim, Suwon-si (KR); Yuyeol Lee, Suwon-si (KR); Juho Lee, Suwon-si (KR); Sungduk Hong, Suwon-si (KR)

(21) Appl. No.: 18/936,639

(22) Filed: Nov. 4, 2024

(30) Foreign Application Priority Data
May 30, 2024 (KR) 10-2024-0070697

(51) Int. Cl. G06F 30/367; H01L 29/786

(52) U.S. Cl. CPC G06F 30/367; H10D 30/6755

(57) ABSTRACT

An electronic device configured for simulating the properties of a semiconductor device and an operating method of the electronic device. The operating method of the electronic device includes determining an oxygen diffusion concentration in a channel layer while simulating a process of removing a portion of an oxygen vacancy in the channel layer in a semiconductor device model; determining a current oxygen vacancy concentration in the channel layer from which the portion of the oxygen vacancy has been removed based on a previous oxygen vacancy concentration in the channel layer and the oxygen diffusion concentration in the channel layer; and predicting the electrical properties of the semiconductor device model based on the current oxygen vacancy concentration.

### CROSS-REFERENCE TO RELATED APPLICATION(S)

This application claims priority to Korean Patent Application No. 10-2024-0070697, filed in the Korean Intellectual Property Office on May 30, 2024, the disclosure of which is incorporated herein by reference in its entirety.

### BACKGROUND

A semiconductor device may include an integrated circuit including metal oxide semiconductor field effect transistors (MOSFETs). With a reduction in the size and design rule of semiconductor devices, the scaling-down of MOSFETs has gradually accelerated. Due to the limitations of a miniaturization process of semiconductor devices, attempts to use an oxide semiconductor (e.g., indium gallium zinc oxide (IGZO)) are increasing. An oxide semiconductor may use an oxygen vacancy as a dopant. An oxygen vacancy may have a significant impact on the electrical properties of a semiconductor device, and thus, the predicting of the oxygen vacancy is important.

### SUMMARY

In general, in some aspects, the present disclosure is directed toward an electronic device and method of predicting an oxygen vacancy concentration for a channel layer of a semiconductor device model, andan electronic device and method of predicting the electrical properties of a semiconductor device model based on an oxygen vacancy concentration.

According to some implementations, the present disclosure is directed to an operating method of an electronic device that includes determining an oxygen diffusion concentration in a channel layer while simulating a process of removing a portion of an oxygen vacancy in the channel layer in a semiconductor device model, determining a current oxygen vacancy concentration in the channel layer from which the portion of the oxygen vacancy has been removed based on a previous oxygen vacancy concentration in the channel layer and the oxygen diffusion concentration in the channel layer, and predicting the electrical properties of the semiconductor device model based on the current oxygen vacancy concentration.

According to some implementations, the present disclosure is directed to an operating method of an electronic device that includes determining a current oxygen vacancy concentration in a channel layer while simulating a process of controlling an amount of an oxygen vacancy in the channel layer in a semiconductor device model and predicting the electrical properties of the semiconductor device model based on the current oxygen vacancy concentration.

According to some implementations, the present disclosure is directed to an electronic device that includes a memory configured to store a simulator configured to simulate a process of removing a portion of an oxygen vacancy for a semiconductor device model and a processor configured to execute the simulator, in which the processor is further configured to determine an oxygen diffusion concentration in a channel layer while simulating the process of removing the portion of the oxygen vacancy from the channel layer in the semiconductor device model, determine a current oxygen vacancy concentration in the channel layer from which the portion of the oxygen vacancy has been removed based on a previous oxygen vacancy concentration in the channel layer and the oxygen diffusion concentration in the channel layer, and predict the electrical properties of the semiconductor device model based on the current oxygen vacancy concentration.

According to some implementations, the present disclosure is direct to predicting an oxygen vacancy concentration in a channel layer based on an oxygen diffusion concentration without an inverse operation from the electrical properties of an actual semiconductor device.

According to some implementations, the present disclosure is directed to predicting electrical properties of a semiconductor device model by using an oxygen vacancy concentration even if an actual semiconductor device is not produced.

### BRIEF DESCRIPTION OF THE DRAWINGS

Example implementations will be more clearly understood from the following description, taken in conjunction with the accompanying drawings.

FIG. 1 is a diagram illustrating an example of an electronic device according to some implementations.

FIG. 2 is a diagram illustrating an example of a semiconductor device model according to some implementations.

FIGS. 3 and 4 are diagrams each illustrating examples of oxygen diffusion according to some implementations.

FIG. 5 is a flowchart illustrating an example of a method of predicting the electrical properties of a semiconductor device model according to simulation that reduces oxygen vacancies according to some implementations.

FIG. 6 is a diagram illustrating an example of a concentration of oxygen that has diffused into a channel layer according to some implementations.

FIG. 7 is a diagram illustrating an example of an oxygen vacancy concentration in a channel layer according to some implementations.

FIGS. 8 to 10 are diagrams each illustrating an example of a method of determining parameters representing the electrical properties of an electronic device according to some implementations.

FIG. 11 is a diagram illustrating an example of a prediction of an oxygen vacancy concentration according to simulation that increases an oxygen vacancy according to some implementations.

### DETAILED DESCRIPTION

Hereinafter, example implementations will be described in detail with reference to the accompanying drawings. When describing the embodiments with reference to the accompanying drawings, like reference numerals refer to like elements and a repeated description related thereto will be omitted.

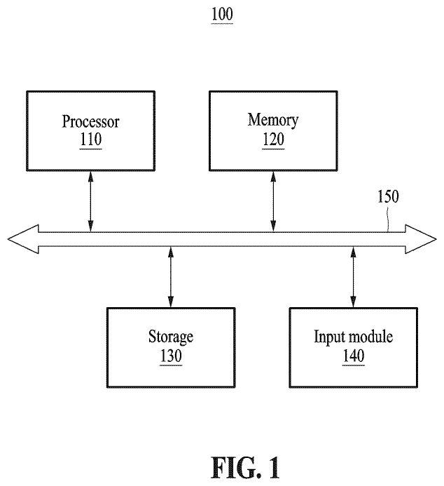

FIG. 1 is a diagram illustrating an example of an electronic device according to some implementations. In FIG. 1, an electronic device 100 includes a processor 110, a memory 120, a storage 130, an input module 140, and a bus 150. The processor 110, the memory 120, the storage 130, and the input module 140 may communicate with one another via the bus 150. Components related to implementations herein may be included in the electronic device 100 illustrated in FIG. 1. Accordingly, the electronic device 100 may also include other general-purpose components in addition to the components illustrated in FIG. 1.

The processor 110 may perform overall functions for controlling the electronic device 100. The processor 110 may obtain a semiconductor device model for simulation by reading data stored in the storage 130.

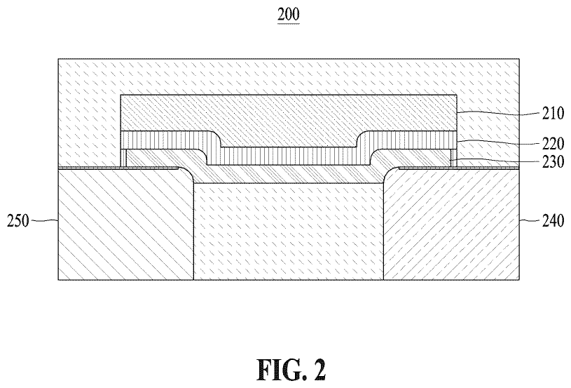

The processor 110 may generate the semiconductor device model from data by using executed tools and may perform various simulations on the semiconductor device model. The processor 110 may process a simulator stored in the memory 120. The processor 110 may predict the properties of the semiconductor device model by performing various simulations on the semiconductor device model by using the simulator. For example, the processor 110 may predict an oxygen vacancy of the semiconductor device model while simulating a process of controlling the number of oxygen vacancies and may predict the properties of the semiconductor device model based on the oxygen vacancy. The oxygen vacancy is used as a dopant in a channel layer in the semiconductor device model, and the properties of the semiconductor device model may vary depending on the concentration of the oxygen vacancy. The detailed description of the oxygen vacancy is provided with reference to FIG. 2.

The processor 110 may be implemented as a central processing unit (CPU), a graphics processing unit (GPU), an application processor (AP), or the like, which is included in the electronic device 100, but the present disclosure is not limited thereto.

The memory 120 may be used as an operation memory of the processor 110. The memory 120 may be hardware for storing data having been processed or to be processed in the electronic device 100. In addition, the memory 120 may store an application or a driver to be driven by the electronic device 100.

The memory 120 may temporarily store instructions and data needed by the processor 110 among the instructions and data stored in the storage 130. The memory 120 may store the simulator that performs the simulation. For example, the memory 120 may store the simulator that simulates a process of removing a portion of the oxygen vacancy for the semiconductor device model.

The memory 120 may include a volatile memory, such as a dynamic random-access memory (DRAM). The memory 120 may include a non-volatile memory, such as a flash memory or resistive RAM (RRAM).

The storage 130 may be used as an auxiliary memory of the electronic device 100. The storage 130 may store commands that configure tools for simulation and data on the semiconductor device model corresponding to a simulation target. The storage 130 may include hard disk drive (HDD), solid-state drive (SSD), and optical disk drive (ODD), but examples are not limited thereto.

The input module 140 may receive commands or data to be used for simulation from the outside of the electronic device 100 (e.g., a user, an external device, etc.). The input module 140 may obtain data on the semiconductor device model from the outside. For example, the input module 140 may include a touch sensor, a keyboard, a mouse, and a digital pen to obtain commands or data from the user. The input module 140 may include a communication module for obtaining commands or data from the external device.

The bus 150 may provide a communication channel among the components of the electronic device 100.

The operations of the electronic device 100 described herein may be performed by a component (e.g., the processor 110) of the electronic device 100.

As described above, the electrical device 100 may predict the electrical properties of the semiconductor device model. The semiconductor device model may be a virtual model, which is a target of a simulation designed by the user, a designer, or the like. The simulation applicable to the semiconductor device model may include simulation for a process (e.g., an annealing process, a baking process, etc.) of controlling the number of oxygen vacancies in the channel layer of the semiconductor device model.

The electronic device 100 may perform a simulation corresponding to the process of controlling the number of oxygen vacancies on the semiconductor device model. The electronic device 100 may predict the oxygen vacancy concentration for the channel layer in which the number of oxygen vacancies has been controlled. The electronic device 100 may predict the electrical properties of the semiconductor device model based on the predicted oxygen vacancy concentration.

The electronic device 100 may predict the electrical properties of the semiconductor device model in an initial research stage of the semiconductor device model using an oxygen vacancy as a dopant. The user of the electronic device 100 who designs the semiconductor device model may determine the structure of the semiconductor device model and the performance time of the process of controlling the number of oxygen vacancies, based on the predicted electrical properties of the semiconductor device model.

Hereinafter, the semiconductor device model, which is a simulation target, is described.

FIG. 2 is a diagram illustrating an example of a semiconductor device model according to some implementations. FIG. 2 illustrates a part of a semiconductor device model 200. The semiconductor device model 200 may be a virtual model, which is a target of simulation implemented in an electronic device.

The semiconductor device model 200 may include a transistor. The transistor may include a MOSFET or a thin-film transistor (TFT). For ease of description, the semiconductor device model 200 is assumed to include an N-type MOSFET herein. However, the descriptions below may also apply to other transistors (e.g., the TFT) implemented in the semiconductor device model 200.

The semiconductor device model 200 may include a gate to which a voltage is applied, a source into which an electron is injected, and a drain from which the electron escapes. The semiconductor device model 200 may include a gate metal 210. The gate metal 210 may include a single layer or a multi-layer. However, the gate metal 210 is not limited to the foregoing examples.

The semiconductor device model 200 may include a gate oxide layer 220. The gate oxide layer 220 may be disposed between the gate metal 210 and a channel layer 230. The gate oxide layer 220 may block a current flow between the gate metal 210 and the channel layer 230 and may transmit a voltage to the channel layer 230.

The semiconductor device model 200 may include the channel layer 230 at a lower part of the gate oxide layer 220. The channel layer 230 may include a single layer or multi-layer of an oxide semiconductor and may include an amorphous, crystalline, or polycrystalline oxide semiconductor. The channel layer 230 may include an oxide semiconductor using an oxygen vacancy as a dopant. The oxygen vacancy is described later.

For example, the semiconductor device model 200 may include an In—Ga—Zn-based oxide (e.g., indium gallium zinc oxide (IGZO)) as the channel layer 230. The In—Ga—Zn-based oxide refers to an oxide having In, Ga, and Zn as main ingredients, but does not refer to a ratio of In, Ga, and Zn. In other words, the channel layer 230 may include IGZO (In:Ga:Zn=1:1:1) including In, Ga, and Zn in the same ratio. The channel layer 230 may include Ga-rich IGZO with a higher ratio of Ga and a lower ratio of In than the IGZO (In:Ga:Zn=1:1:1). The channel layer 230 may include In-rich IGZO with a higher ratio of In and a lower ratio of Ga than the IGZO (In:Ga:Zn=1:1:1).

The semiconductor device model 200 may include a source metal 240. The source metal 240 may include a single layer or a multi-layer. However, the source metal 240 is not limited to the foregoing examples.

The semiconductor device model 200 may include a drain metal 250. The drain metal 250 may include a single layer or a multi-layer. However, the drain metal 250 is not limited to the foregoing examples.

An oxygen vacancy may be generated when oxygen is not bound at a site where it should be bound. When one oxygen vacancy occurs, two free electrons may be formed. As there are more oxygen vacancies, more free electrons are formed. Accordingly, the properties of a semiconductor device may be more like a conductor than a semiconductor. If the channel layer 230 with more oxygen vacancies than needed is deposited onto a semiconductor device, the semiconductor device may operate like a conductor. For the semiconductor device including the channel layer 230 using oxygen vacancies as dopants to maintain semiconductor properties, the process of controlling the number of oxygen vacancies may be performed.

Since an oxygen vacancy plays a dopant role in the semiconductor device model 200, as illustrated in FIG. 1, the oxygen vacancy concentration in the channel layer 230 may be determined for the electronic device to predict the electrical properties of the semiconductor device model 200. In other words, the electronic device may determine the oxygen vacancy concentration in the channel layer 230 where the number of oxygen vacancies is controlled while simulating the process of controlling the oxygen vacancies.

Hereinafter, the controlling of the oxygen vacancies and the diffusion of oxygen are described.

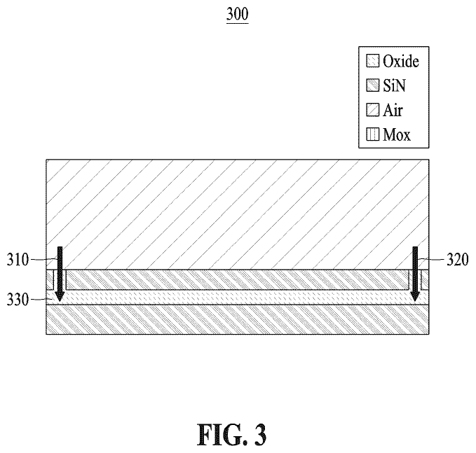

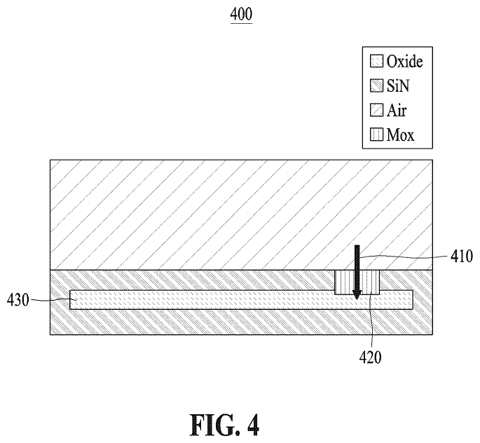

FIGS. 3 and 4 are diagrams each illustrating examples of oxygen diffusion according to some implementations. In FIG. 2, an oxygen vacancy may be generated when oxygen is not bound at a site where it should be bound. Accordingly, to reduce the number of oxygen vacancies, oxygen may need to be bound to the site of an oxygen vacancy.

When manufacturing a semiconductor device, some of the oxygen vacancies may be removed from a channel layer by performing an annealing process or a baking process in an oxygen atmosphere or an air atmosphere. The annealing process and the baking process may be heat-treatment processes. By controlling the temperature and time of the annealing process and the baking process, the number of oxygen vacancies to be removed from the channel layer may be controlled.

FIG. 3 illustrates an example of a semiconductor device model 300 used to describe the oxygen diffusion according to the execution of simulation corresponding to the annealing process in the air atmosphere. The example of the semiconductor device model 300 is used to describe the diffusion of oxygen, and the channel layer may not be shown. Oxygen may diffuse into a semiconductor device through an oxide film 330. The oxide film 330 may serve as a tunnel through which oxygen diffuses. In the semiconductor device model 300, the oxide film 330 may be exposed to the outside. Accordingly, oxygen may diffuse in a first direction 310 and a second direction 320 along the oxide film 330.

FIG. 4 illustrates an example of a semiconductor device model 400 to describe the oxygen diffusion according to the execution of simulation corresponding to the annealing process in the air atmosphere.

The example of the semiconductor device model 400 is used to describe the diffusion of oxygen. In the semiconductor device model 400, a metal oxide film 420 may be exposed to the outside. Oxygen may diffuse into an inward direction 410 of the semiconductor device along the metal oxide film 420. Accordingly, oxygen may diffuse into an oxide film 430 through the metal oxide film 420 even though the oxide film 430 is not exposed to the outside.

In FIGS. 3 and 4, the oxygen diffusion depends on the structure of the semiconductor device, and it may not be easy to predict the oxygen diffusion without using a simulation method. Likewise, it is very difficult to experimentally measure the concentration of oxygen vacancies, and it may also be very difficult to predict the concentration distribution of oxygen vacancies within the channel layer.

Hereinafter, the method of predicting an oxygen vacancy concentration by using an electronic device and predicting the electrical properties of an actual semiconductor device corresponding to a semiconductor device model based on the oxygen vacancy concentration is described.

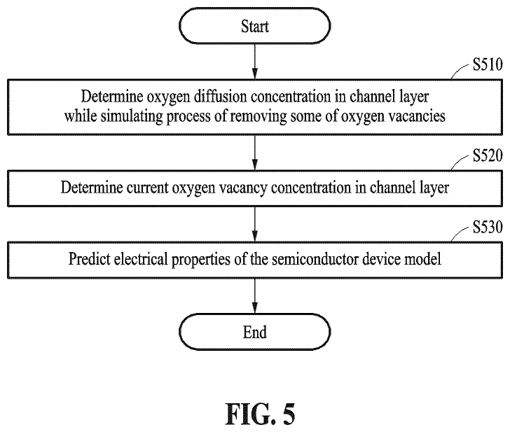

FIG. 5 is a flowchart illustrating an example of a method of predicting the electrical properties of a semiconductor device model according to simulation that reduces oxygen vacancies according to some implementations. In step S510, the electronic device 100 may determine an oxygen diffusion concentration in a channel layer while simulating a process of removing some of the oxygen vacancies in the channel layer in the semiconductor device model.

The electronic device 100 may determine the oxygen diffusion concentration in the channel layer while simulating the process of removing some of the oxygen vacancies from the channel layer in the semiconductor device model.

The electronic device 100 may simulate the process of removing some of the oxygen vacancies for the semiconductor device model including the channel layer using an oxygen vacancy as a dopant. In FIG. 2, the channel layer using an oxygen vacancy as a dopant may include IGZO. The electronic device 100 may determine the oxygen diffusion concentration in the channel layer by simulating the process of removing some of the oxygen vacancies.

The electronic device 100 may determine the oxygen diffusion concentration in the channel layer based on physical property information for each layer included in the semiconductor device model. The physical property information for each layer may include the solubility of each layer, the diffusivity of each layer, and a transfer parameter on a surface. The transfer parameter on a surface may be a parameter indicating the degree of diffusion of atoms on the surface.

The electronic device 100 may determine the oxygen diffusion concentration in the channel layer as a result of the simulation. The oxygen diffusion concentration may be expressed by a function of time and temperature. The oxygen diffusion concentration in the channel layer determined as a result of the simulation may represent the concentration of oxygen supplied to the channel layer through diffusion during a time t during which an annealing process or a baking process is performed at a specific temperature T. The oxygen diffusion concentration in the channel layer determined as a result of the simulation may be expressed by D(T, t).

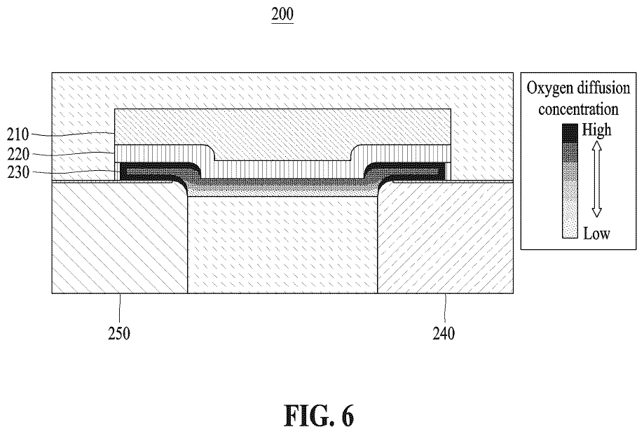

The electronic device 100 may visually display the distribution of the oxygen diffusion concentration in the channel layer as a result of the simulation. The distribution of the oxygen diffusion concentration displayed by the electronic device 100 is described below with reference to FIG. 6.

In step S520, the electronic device 100 may determine a current oxygen vacancy concentration in the channel layer. The electronic device 100 may determine the current oxygen vacancy concentration in the channel layer based on the oxygen diffusion concentration determined in step S510. The electronic device 100 may determine the current oxygen vacancy concentration in the channel layer from which some of the oxygen vacancies have been removed based on a previous oxygen vacancy concentration and the oxygen diffusion concentration.

The electronic device 100 may obtain the previous oxygen vacancy concentration. The previous oxygen vacancy concentration may be experimentally determined based on an actual semiconductor device. The electronic device 100 may receive the previous oxygen vacancy concentration from the outside, may store the previous oxygen vacancy concentration in storage, and may use the previous oxygen vacancy concentration to determine the oxygen vacancy concentration in the channel layer during simulation.

The electronic device 100 may determine the oxygen vacancy concentration in the channel layer after simulation according to Equation 1 below based on the previous oxygen vacancy concentration and the oxygen diffusion concentration. In other words, the electronic device 100 may determine the current oxygen vacancy concentration by subtracting the product of the oxygen diffusion concentration and reactivity from the previous oxygen vacancy concentration.

$${V}_{o , p r e a n n e a l} - R \cdot D ( T , t ) = {V}_{o , a n n e a l e d} \qquad [ Equation 1 ]$$

V_{o,preanneal} denotes the previous oxygen vacancy concentration, which is the oxygen vacancy concentration in the channel layer before a simulation is performed. R denotes reactivity. As described above, D(T, t) denotes the oxygen diffusion concentration in the channel layer determined as a result of the simulation. V_{o,annealed} denotes the current oxygen vacancy concentration, which is the oxygen vacancy concentration in the channel layer after the simulation has been performed.

R denoting reactivity may be a constant. R may be experimentally obtained by calibrating the properties of an actual semiconductor device. According to some implementations, R may be determined differently depending on the order of reaction between oxygen vacancies and oxygen and may be determined as a function over time.

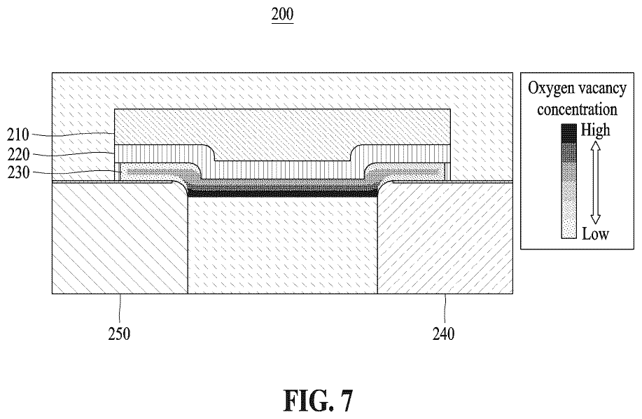

The electronic device 100 may visually display the distribution of the oxygen vacancy concentration in the channel layer. The distribution of the oxygen vacancy concentration displayed by the electronic device 100 is described below with reference to FIG. 7.

In step S530, the electronic device 100 may predict the electrical properties of the semiconductor device model. The electronic device 100 may predict the electrical properties of the semiconductor device model based on the current oxygen vacancy concentration obtained in step S520.

The electrical properties of the semiconductor device model 200 may include a change of a voltage threshold due to a negative bias thermal instability (NBTI) phenomenon. In other words, the electronic device 100 may predict the change of the threshold voltage due to the NBTI phenomenon of the semiconductor device model based on the current oxygen vacancy concentration of the channel layer. An NBTI may be one of the major reliability issues in MOSFETs. The NBTI may be one of the types of aging-related degradation of MOSFETs. The threshold voltage of a MOSFET may increase due to the NBTI phenomenon.

As the oxygen vacancy concentration increases, the deterioration of the MOSFET due to the NBTI phenomenon may get more severe. In other words, the change of the threshold voltage due to the NBTI phenomenon may be proportional to the oxygen vacancy concentration in the channel layer.

The electronic device 100 may predict the change of the threshold voltage due to the NBTI phenomenon based on the current oxygen vacancy concentration based on Equation 2 below.

$$Δ {V}_{th} = P \cdot {V}_{O} \qquad [ Equation 2 ]$$

ΔVₜₕ denotes the change of the threshold voltage due to the NBTI phenomenon. Vₒ may be V_{o,annealed} determined based on Equation 1. In other words, Vₒ denotes the current oxygen vacancy concentration in the channel layer after simulation for controlling oxygen vacancies has been performed. P denotes a compact model that determines an NBTI as a constant for the NBTI phenomenon. For example, Equation 2 may be expressed by Equation 3. The compact model may be a mathematical expression of the properties of a semiconductor device.

$$Δ {V}_{th} = \frac{{P}_{1}}{{P}_{2}} \cdot {E}_{o x}^{{P}_{3}} \cdot {t}^{{p}_{4}} \cdot exp [ \frac{{P}_{5}}{k T} ] \cdot P 6 \cdot {V}_{O} \qquad [ Equation 3 ]$$

Eₒₓ denotes an electrical field generated in a gate oxide layer. T denotes an operating time of the semiconductor device. T denotes an operating temperature of the semiconductor device. Specifically, a unit of T may be Kelvin. P₁ to P₆ may be fitting parameters and may be experimentally measured by using an actual semiconductor device.

The electronic device 100 may predict the change of the threshold voltage based on the current oxygen vacancy concentration and the compact model that determines the NBTI for the semiconductor device model.

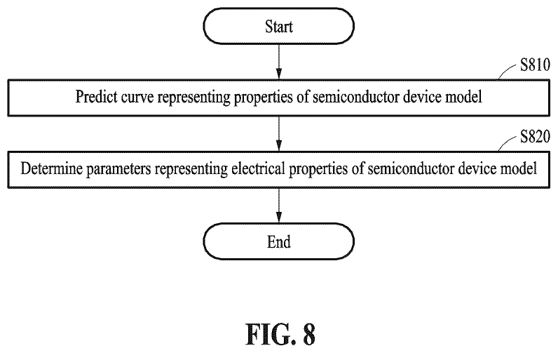

The electronic device 100 may predict curves (e.g., a transfer curve and an output curve) representing the electrical properties of the semiconductor device model in addition to the change of the threshold voltage due to the NBTI phenomenon. The method of the electronic device 100 predicting the curves representing the electrical properties is described below with reference to FIGS. 8 to 11.

FIG. 6 is a diagram illustrating an example of a concentration of oxygen that has diffused into the channel layer 230 according to some implementations. FIG. 6 illustrates the semiconductor device model 200 including the gate metal 210, the gate oxide layer 220, the channel layer 230, the source metal 240, and the drain metal 250. FIG. 6 is provided to describe the distribution of the oxygen diffusion concentration in the channel layer 230, and the descriptions of the gate metal 210, the gate oxide layer 220, the source metal 240, and the drain metal 250 are omitted.

FIG. 6 illustrates the semiconductor device model 200, which visually displays the distribution of the oxygen diffusion concentration in the channel layer 230. An electronic device may visually display the distribution of the oxygen diffusion concentration in the channel layer 230 as a result of performing a simulation for controlling oxygen vacancies. As described above with reference to FIGS. 3 and 4, oxygen may diffuse along the oxide layer. In the semiconductor device model 200, oxygen may diffuse into the channel layer 230 through the gate oxide layer 220.

The oxygen diffused into the channel layer 230 may be bound to oxygen vacancies. More oxygen vacancies may be removed from a region with a high oxygen diffusion concentration compared to a region with a low oxygen diffusion concentration distribution.

FIG. 7 is a diagram illustrating an example of an oxygen vacancy concentration in the channel layer 230 according to some implementations. FIG. 7 illustrates the semiconductor device model 200 including the gate metal 210, the gate oxide layer 220, the channel layer 230, the source metal 240, and the drain metal 250. FIG. 7 is provided to describe the distribution of the oxygen vacancy concentration in the channel layer 230, and the descriptions of the gate metal 210, the gate oxide layer 220, the source metal 240, and the drain metal 250 are omitted.

FIG. 7 illustrates the semiconductor device model 200, which visually displaying the distribution of the oxygen vacancy concentration in the channel layer 230. An electronic device may determine a current oxygen vacancy concentration as a result of performing a simulation for controlling oxygen vacancies and may visually display the current oxygen vacancy concentration in the channel layer 230. Oxygen may diffuse into the channel layer 230 through the gate oxide layer 220. As described above with reference to FIG. 6, more oxygen vacancies may be removed from a region with a high oxygen diffusion concentration compared to a region with a low oxygen diffusion concentration. Accordingly, the distribution of the oxygen vacancy concentration may be inversely proportional to the distribution of the oxygen diffusion concentration.

FIGS. 8 to 10 are diagrams each illustrating an example of a method of determining parameters representing the electrical properties of an electronic device according to some implementations. FIG. 8 is a flowchart illustrating an example of an operating method of the electronic device 100 for determining parameters representing the electrical properties of a semiconductor device model.

In step S810, the electronic device 100 may predict a curve representing the properties of the semiconductor device model. The electronic device 100 may predict a curve representing the properties of the semiconductor device model based on a current oxygen vacancy concentration in a channel layer. The curve representing the properties of the semiconductor device model may include a transfer curve and an output curve. In other words, the electronic device 100 may predict the transfer curve based on the current oxygen vacancy concentration in the channel layer. The electronic device 100 may predict the output curve based on the current oxygen vacancy concentration in the channel layer.

The electronic device 100 may obtain parameters, such as a channel width, a channel length, a source length overlapping with a channel, a drain length overlapping with the channel, the thickness of a channel layer, the thickness of a gate oxide layer, a conduction band carrier concentration, a conduction band carrier mobility, and an acceptor state density function, of the semiconductor device model. The electronic device 100 may receive an input of the foregoing parameters from the outside, may store the received parameters in the storage 130, and may use the stored parameters to predict a curve representing the properties of the semiconductor device model.

The electronic device 100 may predict the curve representing the properties of the semiconductor device model based on the parameters and the current oxygen vacancy concentration. The electronic device 100 may predict the transfer curve of the semiconductor device model based on the parameters and the current oxygen vacancy concentration. The electronic device 100 may predict the output curve of the semiconductor device model based on the parameters and the current oxygen vacancy concentration.

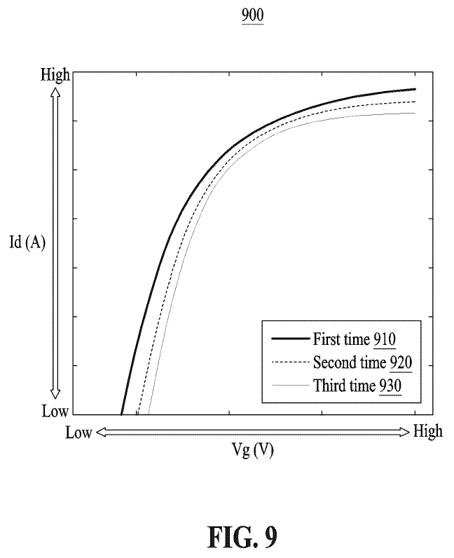

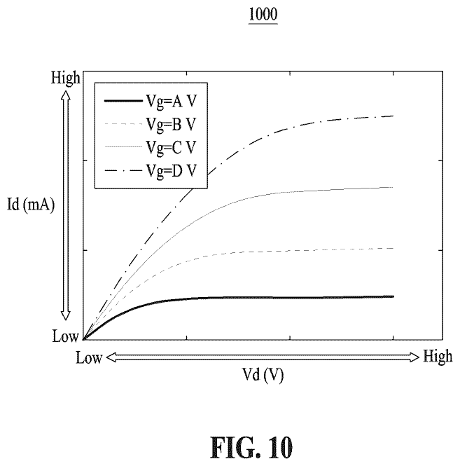

In step S820, the electronic device 100 may determine the parameters representing the electrical properties of the semiconductor device model. The electronic device 100 may determine the parameters representing the electrical properties of the semiconductor device model based on the curve representing the properties of the semiconductor device model obtained in step S810. The electronic device 100 may determine the parameters representing the electrical properties of the semiconductor device model based on the transfer curve. The parameters that may be determined based on the transfer curve are described below with reference to FIG. 9. The electronic device 100 may determine the parameters representing the electrical properties of the semiconductor device model based on the output curve. The parameters that may be determined based on the output curve are described below with reference to FIG. 10.

Hereinafter, the curve representing the electrical properties of the semiconductor device model and the parameters representing the electrical properties of the semiconductor device model are described.

FIG. 9 illustrates an example of a plurality of transfer curves 900 for a semiconductor device model predicted by an electronic device according to some implementations. A transfer curve may be a curve representing a change of a drain current Id due to a change of a gate voltage Vg applied to a gate.

According to some implementations, the electronic device may respectively simulate a plurality of reference processes in the semiconductor device model. The plurality of reference processes may have different process times and/or process temperatures for removing some of the oxygen vacancies. In other words, the electronic device may simulate each of the plurality of reference processes during different process times at the same process temperature. The electronic device may simulate each of the plurality of reference processes during the same process time at different process temperatures. The electronic device may simulate each of the plurality of reference processes during different process times at different process temperatures.

For example, in FIG. 9, the electronic device may simulate a reference process of removing some of the oxygen vacancies from the channel layer in the semiconductor device model during a first time at a first temperature. The electronic device may simulate the reference process of removing some of the oxygen vacancies from the channel layer in the semiconductor device model during a second time at the first temperature. The electronic device may simulate the reference process of removing some of the oxygen vacancies from the channel layer in the semiconductor device model during a third time at the first temperature. Among the first time, the second time, and the third time, the first time may be the shortest. Among the first time, the second time, and the third time, the third time may be the longest. However, the present disclosure is not limited thereto.

For example, the electronic device may simulate the reference process of removing some of the oxygen vacancies from the channel layer in the semiconductor device model during the first time at the first temperature. The electronic device may simulate the reference process of removing some of the oxygen vacancies from the channel layer in the semiconductor device model during the first time at a second temperature. The electronic device may simulate the reference process of removing some of the oxygen vacancies from the channel layer in the semiconductor device model during the first time at a third temperature.

For example, the electronic device may simulate the reference process of removing some of the oxygen vacancies from the channel layer in the semiconductor device model during the first time at the first temperature. The electronic device may simulate the reference process of removing some of the oxygen vacancies from the channel layer in the semiconductor device model during the second time at the second temperature.

The electronic device may determine an oxygen diffusion concentration for each of the plurality of reference processes while simulating each of the plurality of reference processes. The electronic device may predict a transfer curve corresponding to each of the plurality of reference processes based on the oxygen diffusion concentration determined for each of the plurality of reference processes.

For example, the electronic device may predict a transfer curve 910 corresponding to a case where a reference process of controlling an oxygen vacancy is simulated during the first time at the first temperature. The electronic device may predict a transfer curve 920 corresponding to a case where the reference process of controlling an oxygen vacancy is simulated during the second time at the first temperature. The electronic device may predict a transfer curve 930 corresponding to a case where the reference process of controlling an oxygen vacancy is simulated during the third time at the first temperature. For example, the electronic device may predict a transfer curve corresponding to a case where the reference process of controlling an oxygen vacancy is simulated during the first time at the first temperature. The electronic device may predict a transfer curve corresponding to a case where the reference process of controlling an oxygen vacancy is simulated during the first time at the second temperature. The electronic device may predict a transfer curve corresponding to a case where the reference process of controlling an oxygen vacancy is simulated during the first time at the third temperature. For example, the electronic device may predict a transfer curve corresponding to a case where the reference process of controlling an oxygen vacancy is simulated during the first time at the first temperature. The electronic device may predict a transfer curve corresponding to a case where the reference process of controlling an oxygen vacancy is simulated during the second time at the second temperature.

The electronic device may determine the parameters representing the electrical properties of the semiconductor device model for each of the plurality of reference processes based on the transfer curve corresponding to each of the plurality of reference processes. The parameters representing the electrical properties of the semiconductor device model are described below.

The electronic device may determine the parameters representing the electrical properties of the semiconductor device model based on the transfer curve obtained in the method of FIG. 8. The parameters representing the electrical properties of the semiconductor device model that may be obtained from the transfer curve may include parameters, such as a threshold voltage, a subthreshold swing, and an on-off ratio. In addition, the parameters representing the electrical properties of the semiconductor device model may include an on current and an off current.

The threshold voltage may refer to the voltage at which the semiconductor device model operates. The subthreshold swing may refer to a change of a gate voltage required to increase a drain current by 10 times in a range lower than the threshold voltage. The on current may refer to a current that flows when the semiconductor device model is operating. The off current may refer to a current that flows when the semiconductor device model is not operating. The on-off ratio may refer to a ratio of the on current and the off current.

FIG. 10 illustrates an example of an output curve 1000 of a semiconductor device model predicted by an electronic device according to some implementations. The output curve 1000 may be a curve representing a drain current Id according to a drain voltage Vd when a voltage Vg applied to a gate is fixed. In FIG. 10, A V to D V are voltages Vg applied to the gate, and the voltage Vg may increase from A V to D V. However, the present disclosure is not limited thereto.

The electronic device may determine parameters representing the electrical properties of the semiconductor device model based on the output curve 1000 obtained in FIG. 8. The parameters that may be obtained from the output curve 1000 may include parameters, such as a linear region, a saturation region, a threshold voltage, and an on-off ratio.

The linear region may be a region where a drain current increases as a drain voltage increases. The saturation region may be a region where the drain current no longer increases even as the drain voltage increases. Since the threshold voltage and the on-off ratio are described above, the description thereof is omitted.

Like in FIG. 9, when each of a plurality of reference processes with different process times and/or process temperatures for controlling an oxygen vacancy in the semiconductor device model is simulated, the electronic device may predict an output curve corresponding to each of the plurality of reference processes. The electronic device may determine the parameters representing the electrical properties of the semiconductor device model for each of the plurality of reference processes based on the output curve corresponding to each of the plurality of reference processes.

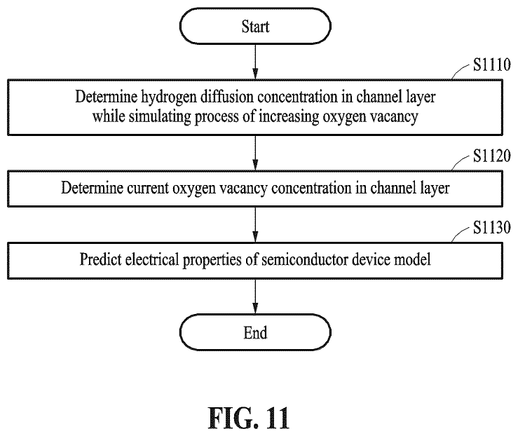

FIG. 11 is a diagram illustrating an example of a prediction of an oxygen vacancy concentration according to simulation that increases an oxygen vacancy according to some implementations. In step S1110, the electronic device 100 may determine a hydrogen diffusion concentration in a channel layer while simulating a process of increasing an oxygen vacancy. The electronic device 100 may determine the hydrogen diffusion concentration in the channel layer while simulating a process of increasing the number of oxygen vacancies in the channel layer in the semiconductor device model.

When manufacturing a semiconductor device, an oxygen vacancy may be increased in the channel layer by performing an annealing process or a baking process in a hydrogen atmosphere. Oxygen may be removed with hydrogen being combined with oxygen such that an oxygen vacancy may be generated. Accordingly, simulation of a process of increasing an oxygen vacancy may include simulation of the annealing process or simulation of the baking process for the semiconductor device model in the hydrogen atmosphere.

The electronic device 100 may determine the hydrogen diffusion concentration in the channel layer as a result of the simulation. The hydrogen diffusion concentration may be expressed by a function of time and temperature. The hydrogen diffusion concentration in the channel layer determined as a result of the simulation may represent the concentration of hydrogen supplied to the channel layer through diffusion during a time t during which the annealing process or the baking process is performed at a specific temperature T. The hydrogen diffusion concentration in the channel layer determined as a result of the simulation may be expressed by D_{H}(T, t).

In step S1120, the electronic device 100 may determine a current oxygen vacancy concentration in the channel layer. The electronic device 100 may determine the current oxygen vacancy concentration in the channel layer based on the hydrogen diffusion concentration determined in step S1110. The current oxygen vacancy concentration may refer to an oxygen vacancy concentration after a simulation has been performed. The electronic device 100 may determine the current oxygen vacancy concentration based on Equation 4 below. In other words, the electronic device 100 may determine the current oxygen vacancy concentration by adding the product of the hydrogen diffusion concentration and reactivity to the previous oxygen vacancy concentration.

$${V}_{o , p r e a n n e a l} + R \cdot {D}_{H} ( T , t ) = {V}_{o , a n n e a l e d} \qquad [ Equation 4 ]$$

V_{o,preanneal} denotes the previous oxygen vacancy concentration, which is the oxygen vacancy concentration in the channel layer before a simulation is performed. R denotes reactivity. As described above, D_{H}(T, t) denotes the hydrogen diffusion concentration in the channel layer determined as a result of the simulation that increases the number of oxygen vacancies. V_{o,annealed} denotes the current oxygen vacancy concentration, which is an oxygen vacancy concentration in the channel layer after the simulation has been performed. Since V_{o,preanneal} and R are described above, the repeated descriptions are omitted.

In step S1130, the electronic device 100 may predict the electrical properties of the semiconductor device model. The electronic device 100 may predict a change of a threshold voltage due to an NBTI phenomenon based on the electrical properties of the semiconductor device model. The electronic device 100 may predict a transfer curve representing the electrical properties of the semiconductor device model and may determine parameters representing the electrical properties of the semiconductor device model based on the transfer curve. The electronic device 100 may predict an output curve representing the electrical properties of the semiconductor device model and may determine parameters representing the electrical properties of the semiconductor device model based on the output curve. The methods of FIGS. 5 to 10 may apply to the method of predicting the electrical properties of the semiconductor device model based on the current oxygen vacancy concentration obtained in step S1120, and thus, the repeated description is omitted.

In FIGS. 5 to 10, the electronic device 100 may determine the current oxygen vacancy concentration in the channel layer while simulating the process of increasing the number of oxygen vacancies and while simulating the process of decreasing the number of oxygen vacancies. In other words, the electronic device may determine the current oxygen vacancy concentration in the channel layer while simulating the process of controlling the number of oxygen vacancies. The electronic device may predict the electrical properties of the semiconductor device model based on the current oxygen vacancy concentration.

Meanwhile, some implementations may also be implemented in a computer-readable medium that stores a program including instructions executable by a computer. The instructions may be stored in the form of program code and, when executed by a processor, may perform the operations of some implementations.

The computer-readable medium may include all types of media that store a program including computer-readable instructions. For example, there may be read-only memory (ROM), random-access memory (RAM), magnetic tape, magnetic disk, flash memory, and optical data storage devices.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination. While the embodiments have been described herein using specific terms, it should be understood that those terms have been used only for describing the technical idea of the present disclosure and not for limiting the sense or the scope of the present disclosure as defined in the claims.

What is claimed is:

1. An operating method of an electronic device, the operating method comprising:
determining, using at least one processor, an oxygen diffusion concentration in a channel layer while simulating a process of removing a portion of an oxygen vacancy in the channel layer in a semiconductor device model;
determining, using the at least one processor, a current oxygen vacancy concentration in the channel layer from which the portion of the oxygen vacancy has been removed based on a previous oxygen vacancy concentration in the channel layer and the oxygen diffusion concentration in the channel layer; and
predicting, using the at least one processor, electrical properties of the semiconductor device model based on the current oxygen vacancy concentration.

2. The operating method of claim 1, wherein the semiconductor device model comprises indium gallium zinc oxide (IGZO) as the channel layer.

3. The operating method of claim 1, wherein determining the current oxygen vacancy concentration in the channel layer comprises:
obtaining the previous oxygen vacancy concentration; and
determining the current oxygen vacancy concentration by subtracting a product of the oxygen diffusion concentration and reactivity from the previous oxygen vacancy concentration.

4. The operating method of claim 1, wherein predicting the electrical properties of the semiconductor device model comprises:
predicting a change of a threshold voltage due to a negative bias thermal instability (NBTI) phenomenon of the semiconductor device model based on the current oxygen vacancy concentration in the channel layer.

5. The operating method of claim 4, wherein predicting the electrical properties of the semiconductor device model comprises:
predicting a change of the threshold voltage based on the current oxygen vacancy concentration and a compact model configured to determine an NBTI for the semiconductor device model.

6. The operating method of claim 1, wherein predicting the electrical properties of the semiconductor device model comprises:
predicting a transfer curve of the semiconductor device model based on the current oxygen vacancy concentration in the channel layer; and
determining a parameter representing the electrical properties of the semiconductor device model based on the transfer curve.

7. The operating method of claim 6, wherein predicting the transfer curve of the semiconductor device model comprises:
when each of a plurality of reference processes are simulated in the semiconductor device model, determining an oxygen diffusion concentration for each of the plurality of reference processes while simulating each of the plurality of reference processes; and
predicting the transfer curve corresponding to each of the plurality of reference processes based on the oxygen diffusion concentration for each of the plurality of reference processes,
wherein determining the parameter representing the electrical properties of the semiconductor device model comprises:
determining the parameter representing the electrical properties of the semiconductor device model for each of the plurality of reference processes based on the transfer curve corresponding to each of the plurality of reference processes,
wherein the plurality of reference processes has different process times and/or process temperatures for removing the portion of the oxygen vacancy.

8. The operating method of claim 6, wherein the parameter representing the electrical properties of the semiconductor device model comprises:
a threshold voltage for the semiconductor device model, a subthreshold swing for the semiconductor device model, and an on-off ratio for the semiconductor device model.

9. The operating method of claim 1, wherein predicting the electrical properties of the semiconductor device model comprises:
predicting an output curve of the semiconductor device model based on the current oxygen vacancy concentration in the channel layer; and
determining a parameter representing the electrical properties of the semiconductor device model based on the output curve.

10. A non-transitory computer-readable medium storing instructions that, when executed by a processor, cause the processor to perform an operating method, the operating method comprising:
determining, using at least one processor, an oxygen diffusion concentration in a channel layer while simulating a process of removing a portion of an oxygen vacancy in the channel layer in a semiconductor device model;
determining, using the at least one processor, a current oxygen vacancy concentration in the channel layer from which the portion of the oxygen vacancy has been removed based on a previous oxygen vacancy concentration in the channel layer and the oxygen diffusion concentration in the channel layer; and
predicting, using the at least one processor, electrical properties of the semiconductor device model based on the current oxygen vacancy concentration.

11. The non-transitory computer-readable medium of claim 10, wherein the semiconductor device model comprises indium gallium zinc oxide (IGZO) as the channel layer.

12. An electronic device comprising:
a memory configured to store a simulator configured to simulate a process of removing a portion of an oxygen vacancy for a semiconductor device model; and
at least one processor configured to execute the simulator,
wherein the at least one processor is further configured to:
determine an oxygen diffusion concentration in a channel layer while simulating the process of removing the portion of the oxygen vacancy from the channel layer in the semiconductor device model:
determine a current oxygen vacancy concentration in the channel layer from which the portion of the oxygen vacancy has been removed based on a previous oxygen vacancy concentration in the channel layer and the oxygen diffusion concentration in the channel layer: and
predict electrical properties of the semiconductor device model based on the current oxygen vacancy concentration.

13. The electronic device of claim 12, wherein the semiconductor device model comprises indium gallium zinc oxide (IGZO) as the channel layer.

14. The electronic device of claim 12, wherein the at least one processor is further configured to obtain the previous oxygen vacancy concentration and determine the current oxygen vacancy concentration by subtracting a product of the oxygen diffusion concentration and reactivity from the previous oxygen vacancy concentration.

15. The electronic device of claim 12, wherein the at least one processor is further configured to predict a change of a threshold voltage due to a negative bias thermal instability (NBTI) phenomenon of the semiconductor device model based on the current oxygen vacancy concentration in the channel layer.

16. The electronic device of claim 15, wherein the at least one processor is further configured to predict a change of the threshold voltage based on the current oxygen vacancy concentration and a compact model configured to determine an NBTI for the semiconductor device model.

17. The electronic device of claim 12, wherein the at least one processor is further configured to predict a transfer curve of the semiconductor device model based on the current oxygen vacancy concentration in the channel layer and determine a parameter representing the electrical properties of the semiconductor device model based on the transfer curve.

18. The electronic device of claim 17, wherein the at least one processor is further configured to, when each reference process of a plurality of reference processes of removing the portion of the oxygen vacancy is simulated in the semiconductor device model:
determine an oxygen diffusion concentration for each of the plurality of reference processes while simulating each of the plurality of reference processes and predict the transfer curve corresponding to each of the plurality of reference processes based on the oxygen diffusion concentration for each of the plurality of reference processes; and
determine the parameter representing the electrical properties of the semiconductor device model for each of the plurality of reference processes based on the transfer curve corresponding to each of the plurality of reference processes,
wherein the plurality of reference processes has different process times for removing the portion of the oxygen vacancy.

19. The electronic device of claim 17, wherein the parameter representing the electrical properties of the semiconductor device model comprises:
a threshold voltage for the semiconductor device model, a subthreshold swing for the semiconductor device model, and an on-off ratio for the semiconductor device model.

20. The electronic device of claim 12, wherein the at least one processor is further configured to predict an output curve of the semiconductor device model based on the current oxygen vacancy concentration in the channel layer and determine a parameter representing the electrical properties of the semiconductor device model based on the output curve.
